(19) United States
(12) Patent Application Publication
(10) Pub. No.: US 2007/0223217 A1
(43) Pub. Date: Sep. 27, 2007

(54) Magnetic induction charged candle

(76) Inventor: Wan-Chang Hsu, Taipei (TW)

Correspondence Address: Hsu, Wan-Chang, P.O.Box 166-13, Taipei, 115, TW

(21) Appl. No.: 11/384,304

(22) Filed: Mar. 21, 2006

(51) Int. Cl. F21L 4/00

(52) U.S. Cl. 362/183; 362/810; 362/392

(57) ABSTRACT

A magnetic induction charged candle includes candle, holder and charger. Said candle and holder are equipped with printed circuit board (PCB), integrated circuit (IC), light emitting diode (LED), battery, switch, and terminal respectively. In that, the terminals can be coupled with each other. Thereby, the candle can be combined and mounted to the holder. At the bottom end of the holder has an electromagnetic coil corresponding to an electromagnetic coil inside the charger. When the holder is place into the charger, an electromotive force is produced between the two electromagnetic coils to induce currents. Thereby, the candle and the holder can be charged at the same time. Even the candle and the holder are not equipped with power line, they can be charged with full capacity of electricity. Moreover, the chargers can be in connection with one another in-line to expand the charging capacity.

### FIELD OF THE INVENTION

The present invention is related to a magnetic induction rechargeable lamp device resembling a candle.

### BACKGROUND OF THE INVENTION

Smoke of the conventional candle is filled with carbon dioxide to foul the air; normally a conventional candlelight is flickered by a gust of wind. To improve this defect, persons skilled in the art have provided electronic candle such as TWM 216,183 entitled “Outdoor Electronic Candle” assigned to Wang, Ker-Kwang on Nov. 11, 1993, in which, Wang taught an electronic “fume” with high brightness, which is suitable for an outdoor lighting system. Or as TWM 240,516 entitled “Structure of Electronic Candle” assigned to Jenesis International Inc. on Aug. 11, 2004, in which, an electronic “fume” can be flickered under oscillation of 2˜3 frequencies. And a photosensitive switch on the printed circuit board can activate light emitting diode (hereinafter abbreviated as LED) in surrounding darkness. Or as U.S. Pat. No. 6,479,965 entitled “Auto-illuminating Rechargeable Lamp System” assigned to Barbel et al. on Nov. 12, 2002, in which, Barbel taught a lamp can be rechargeable by magnetic induction, even the lamp removed from the recharging platter could illuminate, the lamp system turned on automatically during power failure.

According to those two TWM216, 183 and TWM240,516, an electronic candle “fume” with high brightness was not equipped with rechargeable battery pack, therefore, when used a longer while, the consumed-up batteries had been replaced. Or a set of rechargeable batteries was required to take out to charge.

However, the battery pack (120) depicted in FIG. 8 in the U.S. Pat. No. 6,479,965 at least 3 nickel-cadmium (hereinafter abbreviated as Ni-Cad) batteries was depicted to supply power to the lamp system, this battery pack was not only space-occupied, but also cost-inefficiency. Furthermore, the lamp system became an enormous electric apparatus. Suppose the power source without switches to have turned the lamp system on/off promptly, or emitting light modes non-processed by a programmable integrated circuit (hereinafter abbreviated as IC), a flickering candlelight would not have been performed on the lamp device. Moreover, the power source restricted to only one recharging platter supplied power to only one kind of “primary” luminaries directly connected thereto, but not accommodate to more in-line charging platters or charge indirectly “secondary” luminaries. Therefore, under consideration of only one power source outlet, the conventional lamp device equipped with a single charging platter, not a “multi-user” or “multi-tasking” type.

### SUMMARY OF THE INVENTION

Accordingly, the present invention is aimed to provide a magnetic induction charged lamp device. This lamp device includes an electronic candle (hereinafter abbreviated as candle) and a holder, and they are combined in an up and down relationship. Only the holder is positioned into a charger, the candle and the holder combined as a whole can be charged at the same time. After charging, the candle can be separated from the holder. Either candle or holder can emit light in each one's IC processed specific mode. More than one charger can be connected in-line to the same alternate current (hereinafter abbreviated as AC) outlet, and these chargers are to charge different primary and secondary luminaries at the same time.

Point against aforesaid defects, the present invention is aimed to provide a magnetic induction charged lamp device, comprising: a candle includes a housing having diffuser resembling fume, and a second luminary mounted inside the housing; said luminary includes an upstanding printed circuit board (hereinafter abbreviated as PCB), and a light emitting diode (LED) installed to the PCB, a set of rechargeable batteries, a linking terminal, said LED located above the PCB, said terminal exposed below the PCB;

A holder having a base pervious to light, the base being divided into an upper and a lower chambers, a luminary mounted inside the lower chamber, a lid for covering the opening at the bottom end of the lower chamber; said luminary includes a horizontal PCB, a LED installed to the surface of the PCB, a set of rechargeable batteries, a linking terminal, and an electromagnetic coil; said terminal located above the PCB and exposed to the upper chamber, thereby said terminal connected to the terminal of the candle, an electromagnetic coil located below the PCB;

A charger includes a housing, a horizontal PCB mounted inside the housing, and a bottom-lid; said PCB having an electromagnetic coil relative to an electromagnetic coil of the holder, and an outlet for receiving a plug, said outlet exposed outside the housing.

Said luminary of the candle includes IC processing the light emitting modes of LED.

Said luminary of the holder includes IC processing the light emitting modes of LED.

Said PCB of the candle includes a switch exposed outside the housing to switch the power source.

Said PCB of the holder includes a switch exposed outside the bottom lid to switch the power source.

Said charger includes a sheath type plug to connect to a socket of other charger.

Said sheath type plug includes a pressed button exposed outside the housing to determine whether the plug is to pop out or not.

### THE ADVANTAGES OF THE PRESENT INVENTION

After combination of the candle and the holder, place the holder onto the charger, the rechargeable batteries of the candle and the holder can be recharging by magnetic induction, which is produced between the electromagnetic coils inside the charger and the holder. (According to the Farady's Law)

Both of the candle and the holder are portable emitting light devices, when the holder is detached from the candle, each of them can emit light respectively, or they can emit light altogether.

Both of the candle and the holder actuated by a switch respectively determine whether emitting light or not. LED mounted inside the candle or holder is to emit light by programmable IC with specified modes. Charger is equipped with a sheath type plug and a socket, more than one charger, in turn, can be connected to one another by plugging. Only one AC socket is sufficient for many chargers to charge both of primary and secondary luminaries at the same time.

### BRIEF DESCRIPTION OF THE DRAWINGS

FIG. 1 shows an assembled view of the magnetic induction charged lamp device of the present invention.

FIG. 2 shows a cross section view of the magnetic induction charged lamp device of the present invention.

FIG. 3 shows an exploded top view of the holder.

FIG. 4 shows an exploded bottom view of the holder.

FIG. 5 shows an exploded view of the charger.

FIG. 6 shows a schematic view of more than one charger connected in-line.

### DETAILED DESCRIPTION OF THE PREFERRED EMBODIMENTS

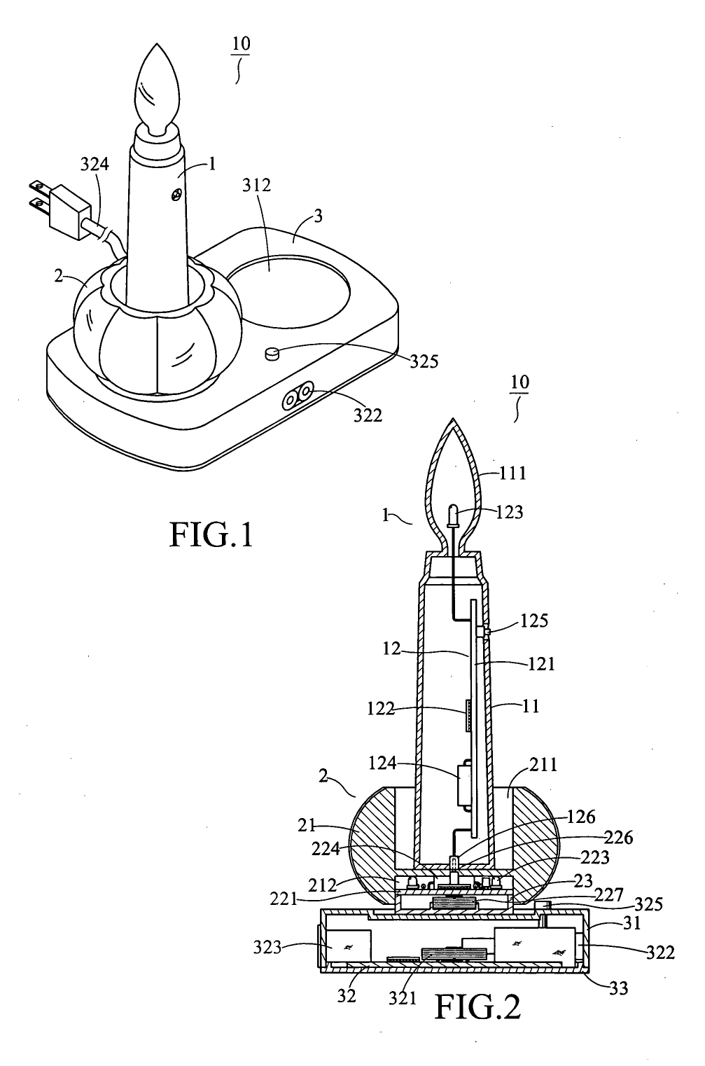

As shown in FIG. 1, the magnetic induction charged lamp device is combined as a whole illustrated with an assembled view. The lamp device 10 includes a candle 1, a holder 2, and a charger 3.

As shown in FIG. 2, a cross sectional view along the profile of the PCB of the magnetic induction charged lamp device is illustrated. Candle 1 having a housing 11 consists of a diffuser 111 shaped like a fume, a luminary 12 mounted inside the housing 11. The luminary 12 includes a PCB 121, an IC 112 installed to the PCB 121, a LED 123 attached to a distal end of an angled wire, the proximal end of the wire is fixed to the higher portion of PCB121, the wire first extended from the PCB 121 horizontally and then bended at a right angle to extend upward, the LED 123 on the distal end of the wire is located above the PCB 121, batteries 124 mounted on the PCB 121, a switch 125 on the PCB 121 controlling the power supply, and a wire having a proximal end fixed to the lower portion of PCB 123, and a linking terminal 126 attached to the distal end of the wire, the wire is first extended from the PCB 123 horizontally and then bended at a right angle to extend downward, therefore, the bended wire with the linking terminal on the distal end is substantially dangled from the PCB 121 to expose the linking terminal 126 below the housing. Said LED 123 located above the PCB 121 is substantially raised inside the fume-like diffuser 111, and PCB 121 is uprightly mounted inside the housing 11, only the manual switch 125 exposed outside the housing 11. Moreover, the linking terminal 126 located and exposed below the housing 11, and a programmable IC 122 is designed to process the emitting lights modes of the LED 123, therefore, the light source can be actuated to show as flickering candlelight.

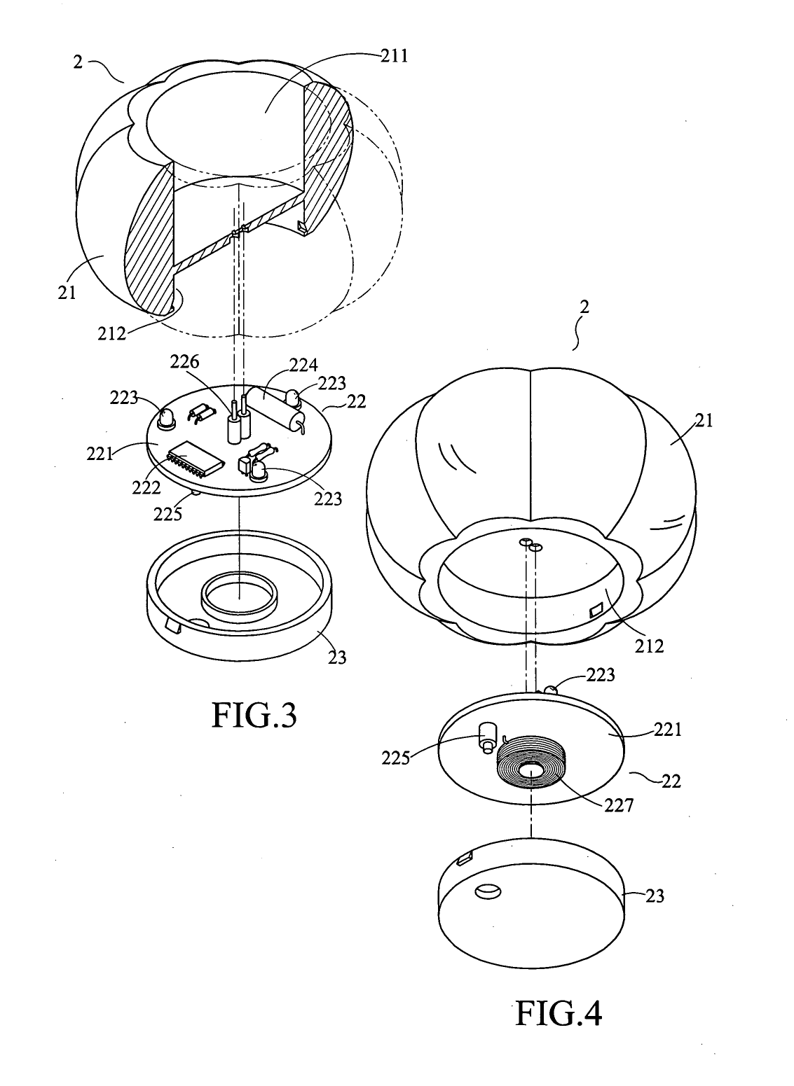

As shown in FIGS. 3 and 4, the top and bottom exploded views of the holder are illustrated. Holder 2 is substantially a base 21 pervious to light including an upper chamber 211, a lower chamber 212, a luminary 22 mounted inside the lower chamber 212, and a lid 23 for covering the opening at the bottom end of the lower chamber. Said luminary 22 includes a horizontal PCB 221 with an IC 222, a LED 223, a battery 224, a switch 225, a linking terminal 226, and electromagnetic coils 227 disposed on the PCB 221. Said IC 222 is to process the emitting light modes of the LED 223. A linking terminal 226 is protruded from the PCB 221 with a second end of the terminal 226 raised into the inner side of the upper chamber 211 of the holder 2. The upper chamber 211 receives a candle 1 fit into the holder 2 and facilitates the second end of the terminal 226 being aligned to the terminal 126 at the bottom of the candle 1. A first end of the terminal 126 is substantially formed like a nut or cap, but the second end of the terminal 226 is substantially shaped like a spindle, after they are aligned to each other, the terminals 126, 226 can be coupled together as a whole. Moreover, electromagnetic coils 227 disposed below the PCB 221 relative to electromagnetic coils 321 inside the charger 3. Thereby, by magnetic induction to induce current between the coils 227, 321 to charge the holder and the candle is designed as desired.

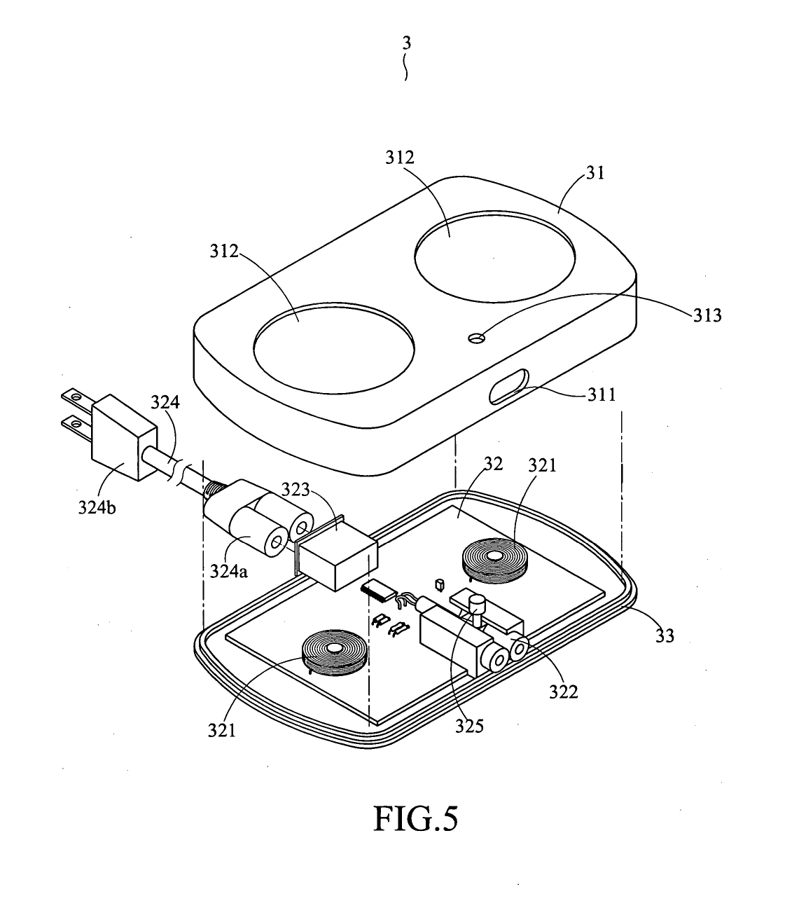

As shown in FIG. 5, an exploded view of the charger is illustrated. Charger 3 includes a housing 31, a horizontal PCB 32 inside the housing, and a lid 33 for shielding the bottom opening of the housing 31; said PCB 32 is equipped with electromagnetic coils 321, a sheath type plug 322 can be flexibly extended outside the hole 311 of the housing, the sheath type plug 322 can plug into an outlet 323; at least one electromagnetic coil 321 is disposed on the PCB 32, said electromagnetic coil 321 corresponds to the electromagnetic coil 227 below PCB 221 to induce currents by magnetic induction. Because each coil having a magnet at its center, when electrified, the magnet change the magnetic flux of electromagnetic coil 321, an electromotive force (emf) is produced to induce currents. According to the well-known Farady's Law, induced currents are reserved in the batteries 124, 224 to light the LEDs.

When said housing 31 is equipped with two electromagnetic coils, two holders will be charged by these two coils. Correspondingly, more electromagnetic coils can electrify more holders at the same time. To facilitate the holder 2 can be placed onto the charger 3 stably, and the electromagnetic coil 321 aligned and relative to the electromagnetic coil 227 in an up and down relationship respectively, a load bearing groove 312 is formed on the top surface of the housing 31 for receiving the holder 2, and the electromagnetic coils 321, 227 can be in vertical alignment with each other.

Moreover, the socket 323 at a first end of the charger 3 is designed to receive a female plug 324a of the conventional AC power line, while a male plug 324b at a second end can plug into a conventional power socket. The socket 323 is also designed to receive sheath type plugs 322 of other charger, said sheath type plug 322 has a button 325 exposed outside the hole 313 of the housing 31, by pressing the button 325 can determine whether the sheath type plug 322 to pop out or not. In other words, after pressing the button 325, the sheath type plug 322 is flexibly extended outside the hole 311 of the housing. Otherwise, by pushing the button 325 in the reverse direction, the sheath type plug 322 can be retracted inside the hole 311 to avoid frictions with something abutted against the sheath type plug.

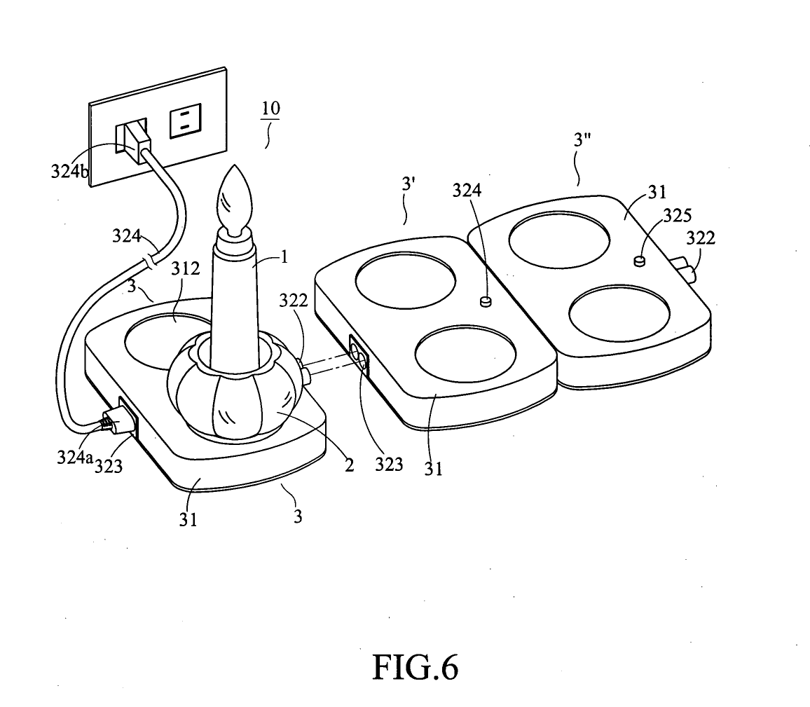

As shown in FIG. 6, a schematic view of the chargers in-line, in serial connection is illustrated. On a first end of the charger 3, socket 323 of the charger 3 is designed to receive a female plug 324a at a second end of an AC power line; while a male plug 324b at a first end of an AC power line plugs into a conventional socket. Thereby, the candle 1 and the holder 2 can be charged simultaneously.

Besides, a sheath type plug 322 exposed outside a first end of the charger 3 is applied to plug into a socket 323 of a second end of the second charger 3′. In turn, the second charger 3′ can plug into the third charger 3″. Thereby, the chargers can be connected one by one in series. The charging capacity can be expanded instead of chargers entangled with the power lines to connect directly to many conventional sockets in one to one respectively, but the sockets are destined not sufficient for the accommodate the charging demands.

When charging, the candle 1 and the holder 2 are not to emit light. For a preemptive warning that the candle 1 and the holder 2 is to re-charge fully, LEDs 123, 223 can emit different color light to show the capacity of the charger.

In practice, the process can be scheduled as following: candle 1 and holder 2 charged with full capacity, after charging, they can be removed from the charger. Each of the candle or holder has a switch exposed outside; the switch can be manually actuated to turn the candle or holder on or off. Therefore, power drain or consumption of the power can be prevented from happened to the users. Or the candle 1 and the holder 2 can emit light together. Or a conventional candle (not shown) can be burned on top of the holder. Moreover, a whole color LED can be adopted as the LED 123 of the candle 1, variant color light can be shown. LED 223 of the holder 2 includes a plurality of conventional LEDs to achieve a time control flickering, or intermittently flickering, or remained bright.

What is claim claimed:

1. A magnetic induction charged candle comprising:
a candle having a housing includes a diffuser resembling a fume on the top end, and a luminary installed inside the housing; said luminary includes a vertical printed circuit board (PCB) with a light emitting diode (LED), a battery, a linking terminal installed to the PCB, said LED raised above the top end of the PCB, said terminal dangled from the PCB to expose the terminal below the housing;
a holder being a base pervious to light having an upper chamber and a lower chamber, a luminary mounted inside the lower chamber, and a lid for covering the opening of the bottom end of the lower chamber, said luminary includes a horizontal PCB with an LED, a battery, a terminal T2, and an electromagnetic coil installed to the surface of the PCB, said terminal is extended from the PCB into the upper chamber to connect to the terminal of the candle, an electromagnetic coil disposed below the PCB;
a charger having a housing, a horizontal PCB mounted inside the housing, and a lid for covering the opening at the bottom end of the housing; said PCB equipped with an electromagnetic coil to correspond to the electromagnetic coil inside the holder, a socket for receiving a sheath type plug, said socket is exposed outside the housing.

2. A magnetic induction charged candle according to claim 1 wherein the luminary of the candle includes integrated circuit (IC) to process the modes of emitting light of the LED.

3. A magnetic induction charged candle according to claim 1 wherein the luminary of the holder includes IC to process the modes of emitting light of the LED.

4. A magnetic induction charged candle according to claim 1 wherein the PCB of the candle is equipped with a switch exposed outside the candle to actuate the candle.

5. A magnetic induction charged candle according to claim 1 wherein the PCB of the holder is equipped with a switch exposed outside the holder to actuate the holder.

6. A magnetic induction charged candle according to claim 1 wherein the charger equipped with a sheath type plug can plug into a socket of other charger.

7. A magnetic induction charged candle according to claim 1 wherein the sheath type plug has a button exposed outside the housing to determine the sheath type plug whether pop out or not.
